(19) United States
(12) Patent Application Publication
(10) Pub. No.: US 2026/0322817 A1
(43) Pub. Date: Oct. 15, 2026

(54) MULTIPLE-PRIVATE NETWORKS UNDER A COMMON ENTITY

(71) Applicant: Tailscale Inc., Toronto (CA)

(72) Inventors: Samuel A. Linville, Raleigh, NC (US); William Norris, Temecula, CA (US); Sonia Appasamy, Brooklyn, NY (US); Marwan Sulaiman, New York, NY (US); Marc Manza, Lindenhurst, NY (US)

(21) Appl. No.: 19/464,130

(22) Filed: Jan. 29, 2026

Related U.S. Application Data
(60) Provisional application No. 63/751,130, filed on Jan. 29, 2025.

(51) Int. Cl. H04L 9/40

(52) U.S. Cl. CPC H04L 63/10; H04L 63/029; H04L 63/083

(57) ABSTRACT

The technology disclosed herein enables an entity to control access to multiple private networks using a single control plane. In a particular example, a method includes in a coordination service for the private networks, receiving a request from a computing element to join a private network of the private networks. The method further includes obtaining an identity associated with the request from an identity provider associated with the entity and applying rules defining which identities associated with the entity are authorized to access which of the private networks. In response to the rules indicating the identity is authorized to access the private network, the method includes sending network configuration information to the computing element. The computing element uses the network configuration information to join the private network.

### RELATED APPLICATIONS

This application is related to and claims priority to U.S. Provisional Patent Application 63/751,130, titled “MULTIPLE-PRIVATE NETWORKS UNDER A COMMON ENTITY,” filed Jan. 29, 2025, and which is hereby incorporated by reference in its entirety.

### BACKGROUND

Organizations often deploy private or virtualized networking environments to secure communications between devices while relying on existing underlying network infrastructure. As these environments grow in scale and complexity, administrators must ensure that devices can be connected securely, configured appropriately, and restricted to only those portions of a network environment that are suitable for their intended use. Managing such connectivity across multiple isolated network environments can create operational challenges, particularly when user access, device configuration, and network isolation requirements must remain consistent and enforceable across diverse systems.

### SUMMARY

The technology disclosed herein enables an entity to control access to multiple private networks using a single control plane. In a particular example, a method includes in a coordination service for the private networks, receiving a request from a computing element to join a private network of the private networks. The method further includes obtaining an identity associated with the request from an identity provider associated with the entity and applying rules defining which identities associated with the entity are authorized to access which of the private networks. In response to the rules indicating the identity is authorized to access the private network, the method includes sending network configuration information to the computing element. The computing element uses the network configuration information to join the private network.

In another example, an apparatus is provided having one or more computer‑readable storage media and one or more processing systems operatively coupled with the one or more computer‑readable storage media. Program instructions stored on the one or more computer‑readable storage media , when read and executed by the one or more processing systems, direct the apparatus to retrieve identity information associated with a computing element attempting to become a node of a private network of the private networks and determine network policies for the private networks allow the computing element to join the private network. The program instructions further direct the apparatus to send first network configuration information to the computing element enabling the computing element to communicate with other nodes on the private network and send second network configuration information to the other nodes enabling the other nodes to communicate with the computing element on the private network.

In a further example, a method includes, in an identity provider, maintaining characteristics of users associated with the common entity to access different subsets of the private networks. The method further includes, in a coordination service for the private networks, maintaining policies indicating which of the characteristics correspond to users being allowed to which of the private networks and assigning private network addresses to computing elements in the private networks. In the coordination service, the method further includes assigning different encryption keys to the computing elements and authenticating a user of a new computing element with the identity provider. The identity provider supplies a characteristic subset of the characteristics associated with the user. In response to determining the policies indicate the characteristic subset allows the user access to a network subset of the private networks, the method includes providing the new computing element with an address subset of the private network addresses and a key subset of the different encryption keys corresponding to the network subset.

### BRIEF DESCRIPTION OF THE DRAWINGS

FIGS. 1 illustrates an implementation for maintaining multiple private networks for users under a common entity.

FIG. 2 illustrates an operation to maintain multiple private networks for users under a common entity.

FIG. 3 illustrates an operational scenario for maintaining multiple private networks for users under a common entity.

FIGS. 4 illustrates an implementation for maintaining multiple private networks for users under a common entity.

FIGS. 5 illustrates an implementation for maintaining multiple private networks for users under a common entity.

FIG. 6 illustrates an operational scenario for maintaining multiple private networks for users under a common entity.

FIG. 7 illustrates an operation to maintain multiple private networks for users under a common entity.

FIG. 8 illustrates a computing system for maintaining multiple private networks for users under a common entity.

### DETAILED DESCRIPTION

A private overlay network is a network built on top of an existing physical network infrastructure (e.g., network interfaces, routers, switches, links, etc.), but with a virtual layer that creates a private and secure communication environment between devices. In an overlay network, connected devices (often referred to as nodes of the private network) can communicate as if they were on a dedicated, isolated physical network, even though they are using a public or shared underlying network. This may be achieved through software-defined networking (SDN) and protocols that allow for greater flexibility, security, and control over the communication traffic that flows between the nodes. Overlay networks are commonly used in virtual private networks (VPNs), distributed systems, and cloud environments to segment traffic, ensuring privacy and performance despite the underlying network's potential vulnerabilities.

Packet encapsulation is a key feature enabling a private overlay network. When data is sent from one node to another within the overlay, the original data packet (often called the payload) is “wrapped” within another, outer packet. This outer packet is constructed according to the rules of the overlay network's protocol, allowing it to be transmitted securely across the public network or the physical infrastructure. For instance, the original data packet may include a header directing the packet to a network address of a device on the private network. Encapsulating the original packet may encrypt the original packet using keys known only to nodes on the private network and then adding a new packet header directing the encrypted data to a public network address for the device. The encapsulation serves two purposes: it provides a secure tunnel for the data, ensuring that the packet can travel without being intercepted or altered by unauthorized entities, and it abstracts the details of the underlying physical network, enabling the overlay network to operate independently of it. Once the packet reaches the destination node, the encapsulation is removed (e.g., the encapsulated packet header is removed and the data is decrypted), and the original payload is processed.

The private networks in the examples below use a coordination service to control the encryption keys and private network addresses (e.g., Internet Protocol (IP) addresses) of computing elements connected to the private network. The coordination service may also handle authentication of a user of the connected computing elements to ensure the computing elements are authorized to connect to and communicate over the private network before supplying the keys and private network addresses. The coordination service may also supply public network addresses of connected computing elements corresponding to the private network addresses. In some examples, relays or other mechanisms may be used that enable communications over the private network without having to supply network addresses of all connected computing elements.

In some situations, an entity, such as a business, may want to implement multiple private networks. While the entity may be able to control each private network independently, it may be difficult to ensure users only have access to a desired portion of the private networks. For example, the business may desire employees in one department to have access to only a subset of the private networks (e.g., to prevent employees outside of the legal department from having access to a private network of legal department devices). When the entity has control of the identity provider used to authenticate users and a domain in which the private networks are located, the entity can control which users have access to which private networks as described below.

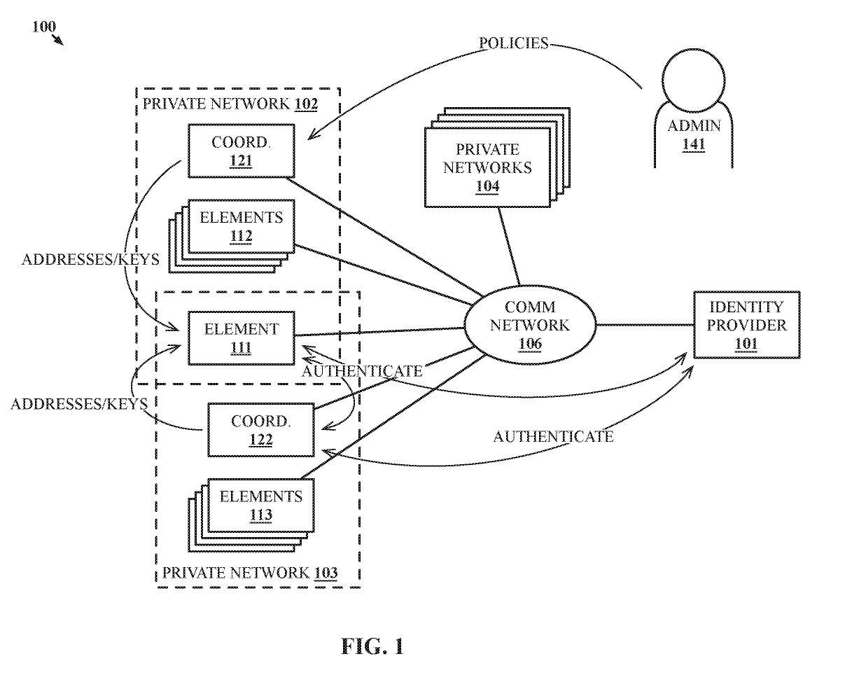

FIGS. 1 illustrates implementation 100 for maintaining multiple private networks for users under a common entity. Implementation 100 includes identity provider 101, private networks 102-104, and communication network 106. Private network 102 connects computing elements 112 and private network 103 connects computing elements 113. Private networks 102-104 are private overlay networks, such as a Virtual Private Network (VPN), that use an authentication mechanism provided by identity provider 101 to ensure computing elements, such as computing elements 112-113 are authorized to join respective ones of private networks 102-104. Private networks 102-104 are logical networks overlaid on physical networking hardware, such wired/wireless communication links, routers, switches, firewalls, computing devices, or other type of components for providing network communications between computing systems. In some examples, at least a portion of the physical networking hardware underlying private networks 102-104 is included in communication network 106. Communication network 106 may include one or more local area networks, wide area networks (e.g., the Internet), or some other type of network.

The overlays for private networks 102-104 are achieved through a process called encapsulation, where the data packets sent between devices are wrapped inside additional packets that include encrypted information. For instance, when an endpoint element (e.g., one of computing elements 112) sends data through private network 102, a packet carrying the data is encrypted and then encapsulated with a new packet header that includes a public IP address of another of computing elements 112 as the destination. This encapsulated packet is then sent over a public network (e.g., communication network 106) to the destination, which removes the encapsulation (e.g., decrypts the payload) to obtain the data therein.

Coordination services 121-122 are instances of a coordination service that manages connections and interactions between devices within private networks 102-104. Each coordination service instance acts as a central authority (e.g., control plane) that facilitates the initial authentication and ongoing management of elements connected to their private network. When a device attempts to join a private network, the device communicates with the coordination service to verify the device-user’s identity, handle key exchanges, and assign network addresses. The coordination service, therefore, ensures only authorized devices can connect and interact with each other over the private network by maintaining an up-to-date directory of valid endpoints and their associated credentials.

Beyond authentication, coordination services 121-122 may also help with routing and maintaining connectivity within private networks 102-104. A coordination service may track the current network topology and support the dynamic updating of device information, such as IP addresses and connection states. This ensures that devices can efficiently discover and communicate with each other, even as they move between different underlying networks or change their connection statuses. By centralizing these functions, use of a coordination service simplifies network management and enhances the overall security and reliability. Coordination services 121-122 are each shown implemented in a single computing device but may be distributed across multiple devices in a private network and may be considered a computing element connected to the private network. Also, while not shown, private networks 104 each include a coordination service instance like coordination services 121-122. Conversely, a single coordination service instance may implement the coordination service for all of private networks 102-104

In this example, coordination services 121-122 use identity provider 101 to perform authentication of computing elements. An identity provider (IdP) plays a crucial role in the authentication process by verifying the identity of users attempting to a private network (or other systems, applications, etc. in other examples). When a user tries to login for their computing element to connect to the private network, the IdP authenticates their credentials, such as usernames and passwords, and issues a token or assertion that confirms their identity. This token is then used by the service or application to grant access to the user. For instance, a computing element may provide the token to coordination service 121 for access to private network 102 and coordination service 121 confirms the token with identity provider 101 prior to granting access. Identity provider may further supply the coordination service with information about the user associated with the token, such as the user’s name, the user’s role, groups of which a user is a part, or other type of information that may be applicable to an access policy.

In operation, administrator 141 is a user managing network access on behalf of an entity having private networks 102-104. Administrator 141 provides policies the coordination service indicating which users have access to which of private networks 102-104. When the coordination service contacts identity provider 101 for authenticating a computing element, identity provider 101 will authenticate a user associated with the computing element and supply information about the user. The coordination service then compares the information to the provided policies to determine to which of private networks 102-104 the user’s computing element can access. Thus, users of computing elements (e.g., personal computers, laptops, smartphones, tablets, servers, virtual machines, or other type of computing devices – including combinations thereof) can authenticate themselves using identity provider 101 but the coordination service will determine whether the user is actually allowed to access any of private networks 102-104.

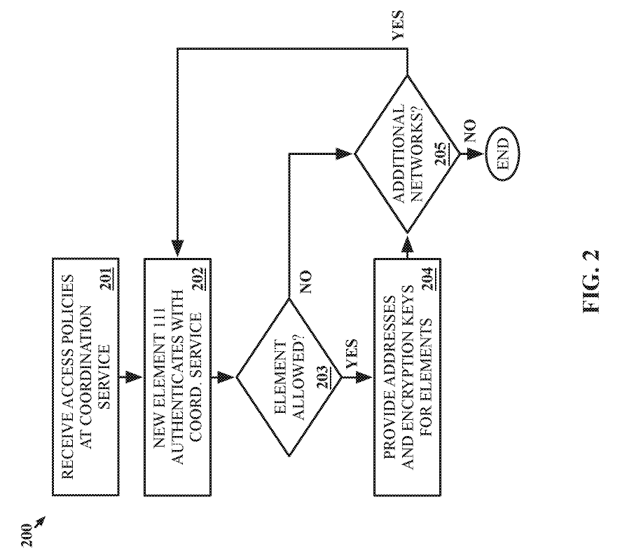

FIG. 2 illustrates operation 200 to maintain multiple private networks for users under a common entity. In operation 200, the coordination service (i.e., coordination service 121 and coordination service 122) receives policies from administrator 141 (step 201). The policies may be obtained in some other manner in other examples. For instance, the policies may be automatically generated based on historical network usage to affect least access privilege for users of private networks 102-104. The policies may be added to, subtracted from, modified, or otherwise updated over time. The policies may define which of private networks 102-104 can be accessed on an individual user basis, on a domain basis (e.g., based on a domain with which a user is associated), on a role basis (e.g., a position in the company), a group basis (e.g., business department of the user), or on some other basis.

In this example, after the policies are implemented in the coordination service, computing element 111 attempts to join private networks 102-104 by authenticating with the coordination service (step 202). For instance, computing element 111 may be a laptop operated by user associated with the entity (e.g., employee or contractor for the entity) and the user may be logging in for the day. Computing element 111 communicates with the coordination service to authenticate the user. In this example, the user is assumed to be human but, in other examples, the user may be a computer system, software process, or some other entity that may use access to one or more of private networks 102-104. The entity may control a Domain Name System (DNS) server that provides public IP addresses for the coordination service. For example, the user of computing element 111 may be associated with a domain name that computing element 111 requests be resolved to an IP address by the DNS server. The DNS server may provide one or more IP addresses the coordination service in private networks 102-104 (e.g., IP addresses for coordination service 121 and coordination service 122).

In an example, computing element 111 contacts coordination service 122 and coordination service 122 directs computing element 111 to contact identity provider 101 for authentication. Computing element 111 contacts identity provider 101 and provides identity provider 101 with credentials of the user of computing element 111. Identity provider 101 authenticates the credentials and supplies a token to computing element 111 (if the user credentials could not be authenticated, identity provider 101 would not provide such a token). Computing element 111 provides the token to coordination service 122 and coordination service 122 checks with identity provider 101 to determine characteristics of the user associated with that token (i.e., the user who requested the token). In this example, the user of computing element 111 is allowed to access private networks 102-103 of private networks 102-104. For example, the policies may indicate that the user is in a group that is allowed to access private network 102 and is in a role that is allowed access to private network 103. Thus, the coordination service determines that computing element 111 should be provided with access to private network 102 and private network 103.

In response to determining that computing element 111 can access private network 103 (step 203), coordination service 122 provides a private IP address on private network 103, a corresponding public IP address on communication network 106, and a different public encryption key for each of computing elements 113 on private network 103 (step 204). Coordination service 122 will also provide a private IP address, corresponding public IP address, and public encryption key for computing element 111 to computing elements 113. Each of computing element 111 and computing elements 113 receives a private encryption key corresponding to their public encryption keys. A sending element encrypts data for encapsulation using the public encryption key for a receiving element. Only the receiving element can then decrypt the data using the corresponding private key.

The coordination service further determines that communication information like that provided for private network 103 above (e.g., IP addresses, keys, etc.) should also be provided for private network 102 (step 205). While shown as a loop, the coordination service may receive the communication information for all allowed private networks in parallel. The communication information for private network 102 may be provided by coordination service 122 or may be provided by coordination service 121 depending on how the coordination service is configured. As such, the coordination service provides the encryption key and addressing information for computing elements 112 to computing element 111 like the coordination service did for computing elements 113 (and provides computing element 111's information to computing elements 112). Using the information received from the coordination service, computing element 111 can now communicate over private network 102.

Advantageously, the entity can use policies for user characteristics supplied by identity provider 101 to ensure computing element 111 can only access a subset of private networks 102-104. The entity controlling private networks 102-104 need only ensure identity provider 101 is up to date with the characteristics of the users (e.g., ensure the roles and groups of users are current) to ensure the policies are properly implemented by the coordination service.

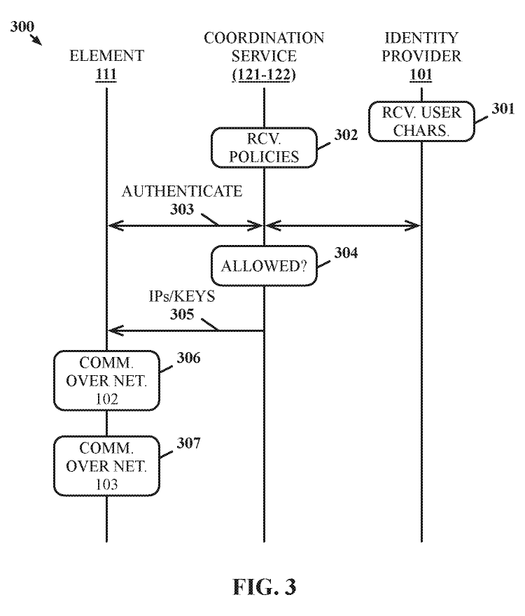

FIG. 3 illustrates operational scenario 300 for maintaining multiple private networks for users under a common entity. In operational scenario 300, identity provider 101 receives user characteristics for users, including a user of computing element 111, that may be authenticated for access to one or more of private networks 102-104 (step 301). Receiving the user characteristics may include receiving a record of a user (e.g., when a user is first hired) with the user’s characteristics, deleting a user’s record (e.g., when a user leaves the entity), updating characteristics in a record of an existing user, or some other type of update to the records for users in identity provider 101. The characteristics may include any information relevant to determining whether a user has access to a particular private network in accordance with one or more policies, such as role, geographic location, groups, etc.

The coordination service also receives policy updates indicating which users should have access to which of private networks 102-104 (step 302). The policies may be new policies, may be modifications to existing policies, may remove existing policies, or may be some other change to the policies indicating which characteristics a user must have to receive access to which of private networks 102-104. For example, a policy may indicate that employees in the Human Resources (HR) department have access to private network 102 and the policy may be updated to indicate that employees in the legal department also have access to private network 102.

With the policies being implemented therein, the coordination service receives a request to access one or more of private networks 102-104 and performs an authentication procedure with identity provider 101 (step 303). The authentication procedure may include directing computing element 111 to authenticate with identity provider 101 and provide the secure token supplied by identity provider 101 in response to that authentication to the coordination service. The coordination service confirms the token with identity provider 101 and receives characteristics of the user of computing element 111. The received characteristics for the user are compared against the policies to determine whether the user is allowed access certain ones of private networks 102-104 (step 304). The coordination service may identify all of the private networks the user can access, In other examples, computing element 111 may indicate to which networks computing element 111 is requesting to connect (e.g., at the instruction of the user). Like in the examples above, the user of computing element 111 is allowed to connect to private network 102 and private network 103 of private networks 102-104.

In response to determining computing element 111 is allowed to access private networks 102-103, the coordination service (e.g., from one or both of coordination services 121-122) provides communication information necessary to communicate over private networks 102-103 to computing element 111 (e.g., IP addresses and encryption keys) (step 305). Computing element 111 uses the communication information to communicate over private network 102 (step 306) and over private network 103 (step 307).

In this example, computing element 111 does not receive access to any other private networks. But, in some examples, policies may enable the user of computing element 111 to access additional (or fewer) private networks.

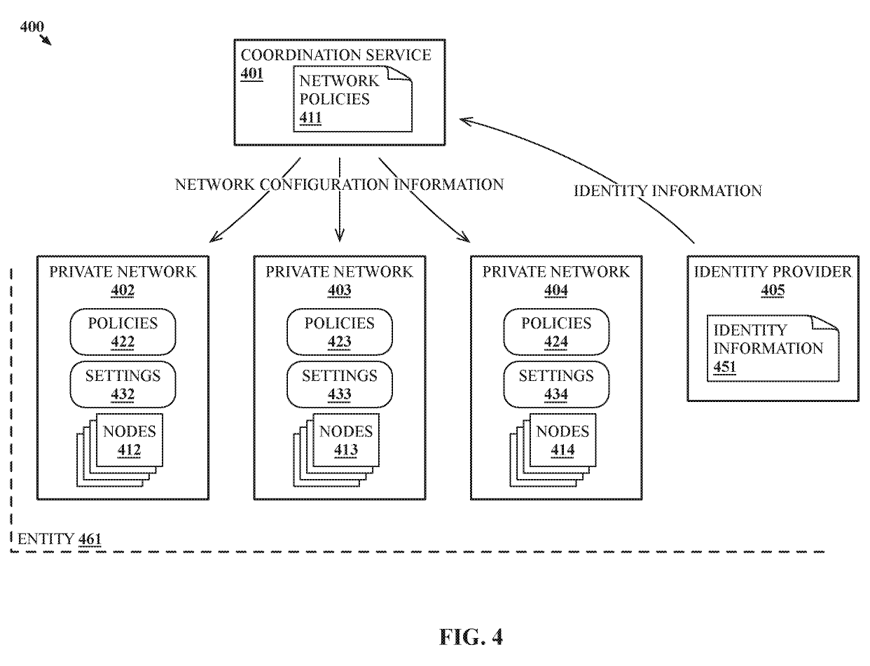

FIGS. 4 illustrates implementation 400 for maintaining multiple private networks for users under a common entity. Implementation 400 includes coordination service 401, private networks 402-404, and identity provider 405. Private networks 402-404 are administered for entity 461. Identity provider 405 is the identity provider for entity 461 and stores or exposes identity information 451 for users and, in some examples, for devices acting under management by entity 461. Coordination service 401 is a system, or collection of systems, that orchestrates configuration and admission control for private networks 402-404. In this example, three private networks are shown for clarity, but entity 461 may operate any number of private networks with the same general arrangement. Coordination service 401 can be deployed as a logically centralized control plane while being physically distributed across data centers for resiliency and low latency. In some examples, coordination service 401 is operated as a multi‑tenant service that manages private networks for multiple entities concurrently while preserving strict isolation between tenants, and in other examples, coordination service 401 is dedicated to a single enterprise deployment of entity 461.

Private network 402 is a private overlay network with nodes 412 configured in accordance with settings 432 and governed by access policies 422. Private network 403 is a separate private overlay network with nodes 413 using settings 433 and governed by access policies 423. Private network 404 is yet another private overlay network with nodes 414 using settings 434 and governed by access policies 424. In some examples, settings 432-434 define address namespaces, routing domains, tunnel parameters, cryptographic suites, DNS behavior, or other communication‑layer configurations that determine how nodes in the respective private networks exchange traffic. Access policies 422-424 can specify communication permissions at various granularities, including identity‑to‑identity rules (e.g., user group to tagged service), node‑to‑node matrices, protocol/port‑specific rules, time‑based restrictions, or contextual constraints such as device compliance posture. Although illustrated as distinct items per network, access policies 422-424 may be partially shared or derived from templates so that entity 461 can apply consistent controls across private networks while still customizing settings 432-434 for environment‑specific needs such as production, staging, and development.

Coordination service 401 obtains network policies 411 that indicate which identities (e.g., individual users, groups, roles, device principals) from identity information 451 are authorized to access which of private networks 402-404. Network policies 411 may be created or updated by an administrator of entity 461 using an administrative interface, may be synchronized from an external policy source, or may be programmatically generated based on historical usage patterns to enforce least‑privilege access. Network policies 411 can be represented as declarative policy files, rule sets, or policy objects and may reference attributes from identity information 451 such as user roles, organizational units, or groups. In some examples, network policies 411 include per‑network admission criteria and per‑network communication constraints so that authorization to join a particular network is distinct from authorization to communicate with specific peers within that network.

Identity provider 405 maintains identity information 451 associated with users of entity 461, such as user names, group memberships, roles, domains, and other attributes applicable to network policies 411. Identity provider 405 can expose identity information 451 to coordination service 401 upon successful authentication of a user or device, and may do so through security tokens, assertions, or directory queries. In some examples, identity information 451 additionally includes device‑level attributes (e.g., device identifiers, attestation or compliance posture) that can be used by coordination service 401 to enforce device‑aware admission decisions into private networks 402–404. Although identity provider 405 is depicted as a single system, identity provider 405 can be realized as multiple identity services that are federated or synchronized, and coordination service 401 can select among them based on a tenant, domain, or realm of the requesting user associated with entity 461.

During operation, coordination service 401 receives join requests from computing elements associated with users of entity 461 and uses network policies 411 in combination with identity information 451 to determine whether a given computing element should be admitted as a node into one or more of private networks 402-404. When admission is permitted, coordination service 401 transmits network configuration information to the requesting computing element and, in some examples, to other affected nodes in the relevant private network to ensure that addressing, cryptographic state, and communication permissions are synchronized. The network configuration information can include, by way of example, an assigned private network address within the namespace of the selected private network, public endpoint information for facilitating tunnel establishment across communication links, cryptographic material for establishing secure channels with other nodes, and access‑control updates that reflect communication allowances under access policies 422-424. In examples using key rotation, coordination service 401 may also schedule or trigger periodic updates of cryptographic material within settings 432-434 to maintain confidentiality and integrity across nodes 412-414.

In some examples, coordination service 401 supports both interactive and non‑interactive admission flows. For interactive flows, a requestor authenticates with identity provider 405, enabling coordination service 401 to obtain identity information 451 that is evaluated against network policies 411 before network configuration information is provided for the requested private network. For non‑interactive flows suitable for automated provisioning, coordination service 401 may validate a pre‑issued credential associated with a particular private network and, when appropriate, issues the corresponding network configuration information without requiring a live identity provider interaction at join time. In either case, coordination service 401 may limit the computing element to only a subset of private networks 402-404 based on network policies 411, and can tailor the network configuration information such that the computing element receives different addressing, cryptographic parameters, and communication permissions for each private network to which it is admitted.

Coordination service 401 may implement additional functions to enhance scalability and reliability. For example, coordination service 401 can maintain cached portions of identity information 451 to reduce latency during policy evaluation, while observing freshness or revocation semantics supplied by identity provider 405. Coordination service 401 may also maintain audit records indicating which identities were admitted to which private networks at which times and under which versions of network policies 411, providing traceability for changes to access policies 422-424 and settings 432-434. In highly available deployments, coordination service 401 can replicate policy state and issued network configuration information across redundant control nodes to support failover without requiring re‑authentication by admitted nodes 412-414. In segmented environments, coordination service 401 may apply namespace translation or policy translation when a computing element participates in more than one of private networks 402-404, thereby preventing address or tag collisions while preserving the intended communication constraints of access policies 422-424.

In some examples, identity provider 405 may assert dynamic attributes within identity information 451 (e.g., location, device health, or session risk scores) that are consumed by coordination service 401 when evaluating network policies 411. This permits entity 461 to implement adaptive policies in access policies 422-424 such that, for example, a user with a particular role is permitted to join private network 403 only when operating from a managed device and during enterprise working hours, while being limited to private network 404 at other times. The same framework allows coordination service 401 to apply fine‑grained communication restrictions between nodes 412-414 after admission, thereby enforcing least‑privilege communication semantics within each of private networks 402-404 based on the combination of static attributes and dynamic context supplied through identity information 451.

Through these mechanisms, implementation 400 enables entity 461 to operate multiple private networks with distinct configuration and access controls while centralizing admission and configuration logic in coordination service 401 and relying on authoritative user and device attributes supplied by identity provider 405. As a result, entity 461 can admit computing elements to only those private networks for which their identities are authorized, distribute distinct network configuration information per network, and maintain consistent, auditable enforcement of access policies 422–424 and settings 432–434 across private networks 402–404.

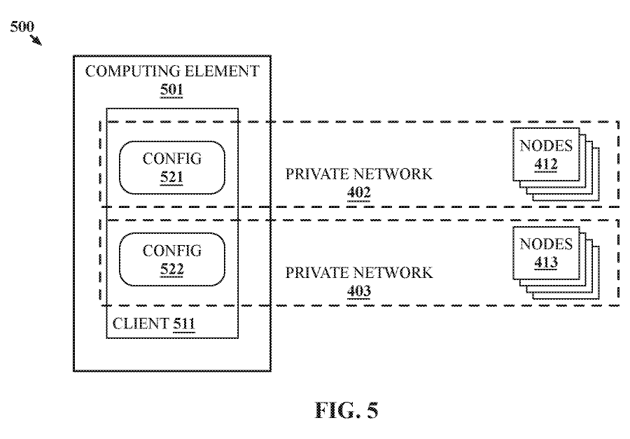

FIGS. 5 illustrates implementation 500 for maintaining multiple private networks for users under a common entity. Implementation 500 includes an example computing element 501 that, in this example, is permitted to join private network 402 and private network 403. Computing element 501 executes client application 511, which interfaces with coordination service 401 and handles private‑network communications as configured by coordination service 401. Client application 511 may be a dedicated agent, a background system process, a module embedded within an operating system, or any other software component capable of receiving configuration information from coordination service 401 and establishing secure communication sessions with nodes in respective private networks.

Client application 511 maintains separate network configuration 521 and network configuration 522 for operation within private network 402 and private network 403, respectively. Each of network configuration 521 and network configuration 522 may include addressing assignments, cryptographic keys, routing directives, allowed‑peer lists, or any other information needed for computing element 501 to behave as a node of the corresponding private network. Network configuration 521 allows computing element 501 to communicate with nodes 412 over private network 402, and network configuration 522 allows computing element 501 to communicate with nodes 413 over private network 403. In some implementations, network configuration 521 and network configuration 522 are stored as distinct profile instances within client application 511 so that the client can selectively activate or deactivate its participation in each private network depending on authorization state, connectivity conditions, or user preference.

Because client application 511 includes both network configuration 521 and network configuration 522, computing element 501 can be considered a member of both node set 412 of private network 402 and node set 413 of private network 403. Some examples may allow computing element 501 to maintain concurrent secure tunnels to nodes 412 and nodes 413, while in other examples, client application 511 may join each private network on demand by activating the corresponding configuration profile. Still other examples may enable seamless movement between private network 402 and private network 403 without requiring a full reauthentication, as long as coordination service 401 has previously issued valid network configuration information for both networks.

Other computing elements may similarly be connected to two or more of private networks 402-404. For example, a developer workstation, build server, or automation appliance may require access to multiple environments, and coordination service 401 can issue configuration information enabling the corresponding client application to participate in any combination of those environments. In some deployments, computing elements may be configured to join three or more private networks, with each network configuration represented by a separate configuration profile like network configuration 521 and network configuration 522. Computing element 501 may update, rotate, or refresh each configuration profile independently, allowing coordination service 401 to enforce different security postures or key‑rotation schedules across private networks 402-404.

Client application 511 may not be configured to communicate over private network 404 because coordination service 401 determined that computing element 501, or the user associated with computing element 501, is not permitted to join private network 404 based on network policies 411. In another scenario, client application 511 may lack network configuration for private network 404 simply because computing element 501 has not yet requested access, or because private network 404 is intentionally hidden or unlisted from computing element 501’s initial network‑selection interface. In some embodiments, client application 511 may only obtain a configuration profile for private network 404 if computing element 501 provides a special identifier, link, or credential associated with private network 404.

In additional examples, client application 511 may include logic to manage simultaneous membership in multiple private networks with differing network conditions, policies, or addressing schemes. For example, client application 511 may maintain distinct secure tunnels, routing table entries, DNS overrides, or service‑discovery scopes for each of network configuration 521 and network configuration 522. If computing element 501 communicates with nodes 412 and nodes 413 simultaneously, client application 511 may isolate network traffic for private network 402 from network traffic for private network 403 to prevent leakage between environments. Such isolation may be implemented using virtual interfaces, sandboxed networking stacks, encrypted overlay tunnels, or combinations thereof.

In some cases, coordination service 401 may update network configuration 521 and network configuration 522 independently over time, such as when network policies 422 or network policies 423 are modified by administrators of entity 461. For example, if access policies for private network 402 allow computing element 501 to communicate with additional nodes on that network, coordination service 401 may update network configuration 521 to include new peer information, while leaving network configuration 522 unchanged. Similarly, client application 511 can receive updates restricting previously allowed communication or rotating cryptographic keys for either network configuration 521 or 522 as part of periodic security maintenance. These incremental changes allow computing element 501 to remain operational while ensuring each private network remains compliant with the most recent policies and settings, such as settings 432 and settings 433.

In further examples, client application 511 may support dynamic admission into additional private networks beyond those initially assigned. For example, computing element 501 may later request access to private network 404, triggering coordination service 401 to evaluate the request using network policies 411 and identity information 451. If admission is subsequently permitted, coordination service 401 may transmit a new configuration profile to client application 511, enabling it to function as one of nodes 414 on private network 404. This incremental‑admission behavior allows computing element 501 to evolve in its network membership over time as trust levels, user roles, or organizational needs change.

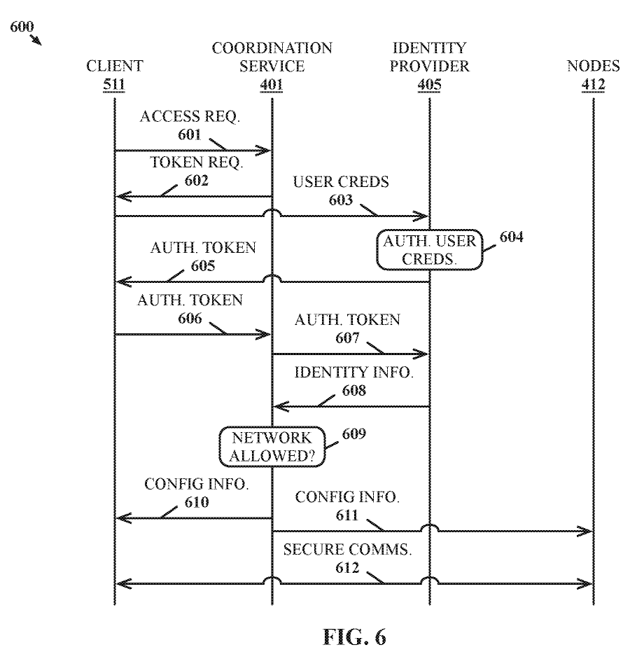

FIG. 6 illustrates operational scenario 600 for maintaining multiple private networks for users under a common entity. Operational scenario 600 depicts one example sequence by which client application 511 obtains access to private network 402 to join nodes 412 and exchange secure communications. Although private network 402 is used for illustration, the same or similar steps may be performed when client application 511 seeks to join private network 403, private network 404, or any other private network associated with entity 461. In some embodiments, the steps shown in operational scenario 600 may be performed in a different order, combined, subdivided, or supplemented with additional steps to accommodate variations in authentication mechanisms, user experience design, or network policy configurations.

Client application 511 transmits an access request message to coordination service 401 requesting to join private network 402 (step 601). The access request may identify the desired private network explicitly or, in some examples, may request that coordination service 401 determine the appropriate private network based on identity information, device information, or user‑selected preferences. In response to receiving the request, coordination service 401 requests an authentication token from client application 511 (step 602). In some embodiments, this token request indicates that coordination service 401 intends to validate the user associated with client application 511 through identity provider 405 before performing network policy evaluation for private network 402.

The token request at step 602 triggers client application 511 to provide user credentials for a user of client application 511 to identity provider 405 (step 603). The user credentials may include, for example, a username and password, a multi‑factor authentication response, a certificate, a federated identity assertion, or any other credential acceptable to identity provider 405. Identity provider 405 authenticates the provided user credentials to determine that the user of client application 511 is a recognized user with identity information contained within identity information 451 (step 604). As an alternative to step 603 and step 604, identity provider 405 may already maintain a valid session for the user and may issue an authentication token without requiring re‑entry of user credentials. In further alternatives, client application 511 may provide a device credential or other non‑user‑interactive credential to identity provider 405 or coordination service 401.

Identity provider 405 generates and provides client application 511 with an authentication token corresponding to the authenticated user (step 605). The authentication token may be a signed assertion that identifies the authenticated user and, in some embodiments, may include additional claims such as group memberships, roles, or device state information. Client application 511 then provides the authentication token to coordination service 401 in response to the earlier token request (step 606). In some embodiments, client application 511 may also provide supplementary device‑level credentials or metadata in addition to the authentication token.

Coordination service 401 forwards the authentication token to identity provider 405 for validation and attribute retrieval (step 607). Identity provider 405 recognizes the authentication token as the previously issued token for the user of client application 511 and supplies the portion of identity information 451 associated with that user to coordination service 401 (step 608). In some examples, identity information 451 may include user roles, group memberships, organizational affiliation, domains, device attributes, or any other identity‑related characteristic referenced by network policies 411.

Based on the received identity information, coordination service 401 determines that network policies 411 indicate that the user of client application 511 is allowed to access private network 402 (step 609). This authorization decision may consider static characteristics (e.g., roles or groups), dynamic characteristics (e.g., device posture or risk scoring), or context‑dependent conditions (e.g., time of day, network location, or administrative override). In some embodiments, the evaluation at step 609 may determine that the user is authorized to join multiple private networks, and client application 511 may subsequently request configuration information for additional private networks.

After determining that access to private network 402 is permitted, coordination service 401 provides network configuration 521 to client application 511 (step 610). Network configuration 521 may include a private network address assigned from the namespace of private network 402, cryptographic keys or certificates for establishing secure tunnels with nodes 412, routing or DNS configuration parameters, and access‑control information identifying which nodes 412 the client application 511 is permitted to communicate with. Coordination service 401 also provides configuration information to nodes 412 (step 611) so that nodes 412 can recognize computing element 501 as a permitted participant within private network 402 and establish secure communication sessions.

Secure communications may then be exchanged between client application 511 and nodes 412 (step 612) using the cryptographic material and addressing details included within network configuration 521. In some embodiments, step 612 may involve direct peer‑to‑peer communications, relay‑assisted communications if direct connectivity is not available, or encapsulated traffic patterns suitable for traversing network address translation or firewall boundaries. In alternative embodiments, client application 511 may repeat steps 601-612 to join private network 403 or private network 404, or may request simultaneous admission into multiple private networks if authorized by network policies 411.

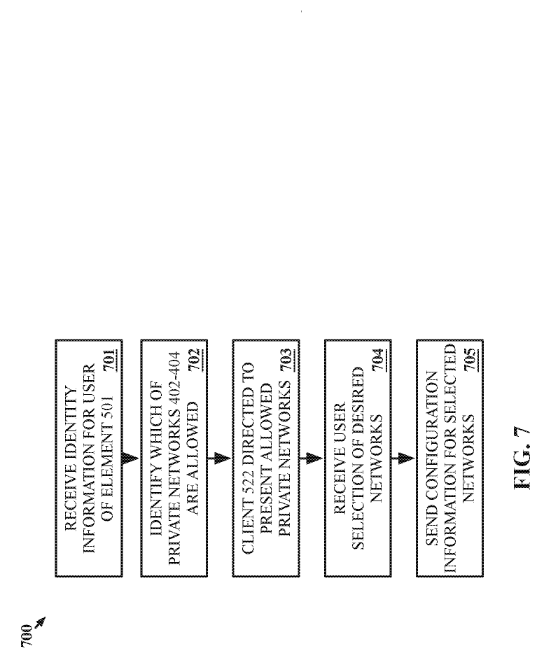

FIG. 7 illustrates operation 700 to maintain multiple private networks for users under a common entity. Operation 700 provides an example of a user‑driven workflow in which computing element 501 may be permitted to join one or more private networks 402-404 based on identity information obtained from identity provider 405 and evaluated against network policies 411 by coordination service 401. Although operation 700 illustrates a particular order of steps, the order may vary depending on system design, user interface preferences, or authentication model. Additionally, the operations of FIG. 7 may be combined with or substituted for portions of the authentication‑driven workflow shown in operational scenario 600 of FIG. 6.

Coordination service 401 receives identity information for computing element 501 (step 701). Step 701 may occur as part of an authentication sequence (such as steps 602-608 of FIG. 6), may occur through a cached identity record that identity provider 405 previously provided, or may occur through a non‑interactive credential exchange, such as when client application 511 provides an authenticated device credential or a pre‑issued enrollment key. Identity information received at step 701 may include information describing a user, a device, a service principal, or a combination thereof.

Based on the identity information, coordination service 401 identifies which of private networks 402–404 client application 511 is allowed to access by applying network policies 411 to the identity information (step 702). The evaluation at step 702 may reference characteristics such as user groups, organizational roles, device health state, administrative assignments, or any other attributes included in identity information 451. In some examples, network policies 411 may cause coordination service 401 to determine at step 702 that client application 511 is authorized to access only a single private network, while in other examples, client application 511 may be permitted to access any combination of private networks 402-404.

Coordination service 401 directs client application 511 to present the user with a list of networks available to client application 511 (step 703). The list may show only the private networks for which client application 511 is authorized at step 702, may show all private networks 402-404 regardless of authorization (with unauthorized networks visually distinguished), or may show a filtered subset of private networks based on administrative configuration or user role. In some embodiments, private network 404 may be hidden by default, and client application 511 may reveal private network 404 only when the user provides a special identifier or access code.

The user of client application 511 selects their desired private networks (step 704). The selection may include one network or multiple networks. In some examples, client application 511 may prompt the user to confirm selection of a network requiring elevated permission or may automatically join networks that do not require explicit user confirmation. In alternative embodiments, step 704 may be omitted entirely if network policies 411 grant client application 511 access to only a single private network or if client application 511 automatically joins private networks without user interaction.

Coordination service 401 sends configuration information for the selected private networks at step 705. Configuration information may include network configuration 521 for private network 402, network configuration 522 for private network 403, configuration profiles for private network 404, or any combination thereof. For example, if the user selects private network 402 and private network 403, coordination service 401 provides network configuration 521 and network configuration 522 to client application 511. In some implementations, coordination service 401 also sends configuration updates to nodes 412-414 of the selected networks to ensure that those nodes can communicate with computing element 501 as a newly admitted participant.

In alternative examples, client application 511 may display all networks under entity 461 at step 703 (i.e., private networks 402-404) and determine whether the user is allowed to access the selected networks only after receiving the user’s selection at step 704. In this alternative sequence, network policies 411 are applied after selection rather than before selection. If the user selects a private network for which the user is not authorized, client application 511 may notify the user of the denial, request reauthentication, request additional credentials, or provide instructions to the user for seeking administrative approval. In yet another variation, coordination service 401 may automatically admit client application 511 to private networks for which the user is authorized at step 702, and step 704 may be used solely to determine which networks should be activated immediately versus which networks should remain inactive until needed.

In some examples, one or more private networks are intentionally hidden from the list presented to the user at client application 511, and admission to such a hidden network requires the user to supply a corresponding network identifier. In this variation, client application 511 may initially display only a subset of private networks 402-404 that are not designated as hidden, while also providing an input control for entry of a network identifier (e.g., an alphanumeric code, a URI containing the identifier, or an invitation token) associated with a hidden network. When the user supplies the network identifier within the selection interface, client application 511 treats the input as a selection of that hidden network for purposes of network choice, and coordination service 401 then validates the identifier against network policies 411 and the user’s identity information before proceeding. If validation succeeds, coordination service 401 transmits configuration information for the hidden network to client application 511, thereby enabling client application 511 to join the hidden network while keeping the network undisclosed to users who lack knowledge of the identifier.

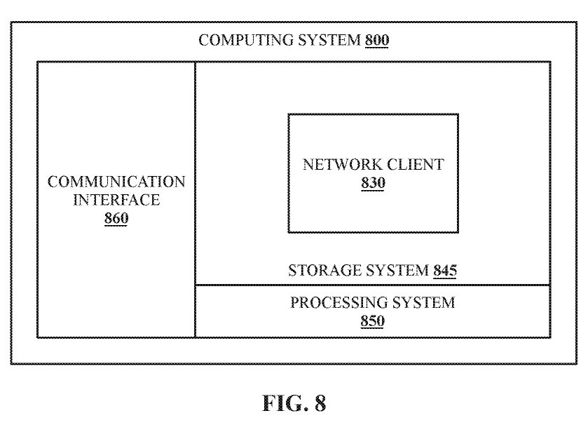

FIG. 8 illustrates computing system 800 for maintaining multiple private networks for users under a common entity. Computing system 800 is representative of any computing system or systems with which the various operational architectures, processes, scenarios, and sequences disclosed herein can be implemented. Computing system 800 is an example architecture for identity provider 101, coordination services 121-122, coordination service 401, computing element 501, and computing elements 111-113, although other examples may exist. Other systems may also use similar architectures. Computing system 800 includes storage system 845, processing system 850, and communication interface 860. Processing system 850 is operatively linked to communication interface 860 and storage system 845. Communication interface 860 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format – including combinations thereof. Communication interface 860 may be configured to communicate with other computing systems via one or more networks.

Processing system 850 comprises microprocessor and other circuitry that retrieves and executes operating software from storage system 845. Storage system 845 may include volatile and nonvolatile, removable, and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 845, or any other computer-readable storage medium herein, be considered a transitory form of signal transmission (often referred to as "signals per se"), such as a propagating electrical or electromagnetic signal or carrier wave.

Processing system 850 is typically mounted on a circuit board that may also hold the storage system. The operating software of storage system 845 comprises computer programs, firmware, or some other form of machine-readable program instructions. The operating software of storage system 845 comprises network client 830. The operating software on storage system 845 may further include an operating system, utilities, drivers, network interfaces, applications, or some other type of software. When read and executed by processing system 850 the operating software on storage system 845 directs computing system 800 to control access to private networks under a common entity, as described herein. Network client 830 may execute natively on processing system 850 or the operating software may include virtualization software, such as a hypervisor, to virtualize computing hardware on which network client 830 executes.

In at least one example, network client 830 executes on processing system 850 and computing system 800 to retrieve identity information associated with a computing element attempting to become a node of a private network of the private networks and determine network policies for the private networks allow the computing element to join the private network. Network client 830 further directs computing system 800 to send first network configuration information to the computing element enabling the computing element to communicate with other nodes on the private network and send second network configuration information to the other nodes enabling the other nodes to communicate with the computing element on the private network.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for controlling access across private networks of an entity, the method comprising:
in a coordination service for the private networks, receiving a request from a computing element to join a private network of the private networks;
obtaining an identity associated with the request from an identity provider associated with the entity;
applying rules defining which identities associated with the entity are authorized to access which of the private networks; and
in response to the rules indicating the identity is authorized to access the private network, sending network configuration information to the computing element, wherein the computing element uses the network configuration information to join the private network.

2. The method of claim 1, comprising:
receiving a second request from the computing element to join a different private network of the private networks; and
in response to the rules indicating the identity is authorized to access the different private network, sending different network configuration information to the computing element, wherein the computing element uses the different network configuration information to join the different private network.

3. The method of claim 1, comprising:
receiving a second request from the computing element to join a different private network of the private networks; and
in response to the rules indicating the identity is not authorized to access the different private network, denying the second request.

4. The method of claim 1, wherein obtaining the identity comprises:
receiving an authentication token from the computing element, wherein the identity provider granted the authentication token to the computing element in response to authenticating a user of the computing element; and
querying the identity provider for the identity associated with the authentication token.

5. The method of claim 1, comprising:
receiving the rules from an administrator of the private networks for the entity.

6. The method of claim 1, wherein the rules indicate with which other nodes in the private network the computing element can communicate.

7. The method of claim 1, wherein the network configuration information includes a private network address for the computing element within a namespace of the private network, and wherein a different private address is assigned to the computing element in a different private network of the private networks.

8. The method of claim 1, wherein the network configuration information includes encryption keys for establishing tunnels between nodes on the private network, and wherein different encryption keys are used to establish tunnels between nodes on a different private network of the private networks to which the computing element is joined.

9. The method of claim 1, comprising:
after applying the rules, sending a message indicating a subset of the private networks the computing element is allowed to join, wherein the computing element receives user input selecting the private network from the subset and sends the request in response to the user input.

10. The method of claim 9, wherein the user input selects at least one other private network of the private networks, and wherein the request also requests to join the at least one other private network.

11. The method of claim 9, wherein the private network is hidden from presentation at the computing element while at least one other network in the subset is presented for selection, and wherein the user input comprises an identifier for the private network.

12. The method of claim 1, wherein the identity comprises one or more items of information including:
a name of a user associated with the computing element,
a role of the user,
a group in which the user is a member, and
a domain of the user.

13. An apparatus to control access across private networks of an entity, the apparatus comprising:
one or more computer‑readable storage media;
one or more processing systems operatively coupled with the one or more computer‑readable storage media; and
program instructions stored on the one or more computer‑readable storage media that, when read and executed by the one or more processing systems, direct the apparatus to:
retrieve identity information associated with a computing element attempting to become a node of a private network of the private networks;
determine network policies for the private networks allow the computing element to join the private network;
send first network configuration information to the computing element enabling the computing element to communicate with other nodes on the private network; and
send second network configuration information to the other nodes enabling the other nodes to communicate with the computing element on the private network.

14. The apparatus of claim 13, wherein the first network configuration information includes private network addresses and corresponding public network addresses of the other nodes and the second network configuration information includes a private network address and corresponding public network address of the computing element.

15. The apparatus of claim 13, wherein to retrieve the identity information, the program instructions direct the apparatus to:
instruct the computing element to authenticate itself with an identity provider of the entity;
receive an authentication credential from the computing element, wherein the computing element received the authentication credential from the identity provider in response to the identity provider authenticating a user of the computing element; and
query the identity provider for the identity information associated with the authentication credential.

16. The apparatus of claim 13, wherein the program instructions direct the apparatus to:
receive the network policies from an administrator, wherein the network policies indicate which items of identity information enable access to which of the private networks.

17. The apparatus of claim 13, wherein the first network configuration information includes access control policies for the private network indicating with which of the other nodes the computing element is allowed to communicate.

18. The apparatus of claim 13, wherein the program instructions direct the apparatus to:
determine the network policies allow the computing element to join a different private network of the private networks;
send third network configuration information to the computing element enabling the computing element to communicate with different other nodes on the different private network; and
send fourth network configuration information to the different other nodes enabling the different other nodes to communicate with the computing element on the different private network.

19. The apparatus of claim 18, wherein at least one of the other nodes is included in the different other nodes.

20. A method for managing private networks under a common entity, the method comprising:
in an identity provider, maintaining characteristics of users associated with the common entity to access different subsets of the private networks; and
in a coordination service for the private networks:
maintaining policies indicating which of the characteristics correspond to users being allowed to which of the private networks;
assigning private network addresses to computing elements in the private networks;
assigning different encryption keys to the computing elements;
authenticating a user of a new computing element with the identity provider, wherein the identity provider supplies a characteristic subset of the characteristics associated with the user; and
in response to determining the policies indicate the characteristic subset allows the user access to a network subset of the private networks, providing the new computing element with an address subset of the private network addresses and a key subset of the different encryption keys corresponding to the network subset.
